(19) United States
(12) Patent Application Publication
(10) Pub. No.: US 2009/0167078 A1
(43) Pub. Date: Jul. 2, 2009

(54) Vehicle conductor

(75) Inventor: Kunihiko Watanabe, Yokkaichi-shi (JP)

Correspondence Address: OLIFF & BERRIDGE, PLC, P.O. BOX 320850, ALEXANDRIA, VA, 22320-4850, US

(73) Assignees: Autonetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 11/991,003

(22) PCT Filed: Sep. 13, 2006
(86) PCT No.: PCT/JP2006/318161

§ 371 Date: Feb. 26, 2008

(30) Foreign Application Priority Data
Sep. 13, 2005 (JP) 2005-265531

(51) Int. Cl. H02G 3/00

(52) U.S. Cl. 307/10.1

(57) ABSTRACT

A vehicle conductor for use with an electric automobile can include a protection pipe including a wire in the protection pipe capable of supplying power, and a cooling pipe positioned proximate the wire in the protection pipe.

### TECHNICAL FIELD

The present invention relates to a vehicle conductor.

### BACKGROUND ART

A known vehicle conductor to be mounted in an electric automobile has a braided electromagnetically shielding member constituted by braided wires made by braiding thin metal wires into a tubular mesh. The shielding member encloses, and thereby collectively shields, a plurality of non-shielded wires. In this type of vehicle conductors, as a general method for protecting the shielding member and the wires, the shielding members are enclosed with a protector made of synthetic resin. However, there is a problem that use of the protector causes increase of number of parts.

Therefore, the applicant of the present invention proposed a construction wherein non-shielded wires are inserted in a metal pipe, as disclosed in Patent Document 1. With this construction, the pipe performs a shielding function for the wires, as well as a protecting function for the wires. Therefore, there is an advantage that the number of parts is less than that of the vehicle conductor using the shielding member and the protector.

### [Patent Document 1] Japanese Unexamined Patent Application Publication No. 2004-171952

### DISCLOSURE OF THE INVENTION

### Problem to be Solved by the Invention

In the vehicle conductor with the pipe, air exists in the space between the wires and the pipe. Since air has lower heat conductivity, heat generated in the wires when current flows through the wires is blocked by the air and difficult to be transferred to the pipe. Furthermore, the pipe has no air path to the outside associated with pores defined by the wires of the braided wires. Therefore, the heat generated in the wires is stored inside the pipe, and the conductor tends to perform lower heat dissipation.

Note that, when a certain amount of current flows through a wire, the larger cross-sectional area of the wire is, the less heat is generated therein; and the higher heat dissipation a vehicle conductor performs, the temperature value increase in the wire deriving from the heat generation is restrained. Accordingly, in an environment where a limit is determined for the temperature increase value of the wire, it is necessary for a vehicle conductor performing lower heat dissipation to enlarge the cross-sectional area of each of the wires in order to inhibit the heat generation.

Enlargement of the cross-sectional area of the each wire, however, causes enlargement in diameter, as well as increase in weight, of the vehicle conductor. Some countermeasure thus becomes necessary.

The present invention was achieved in accordance with the foregoing circumstances, and its object is to improve the heat dissipation efficiency.

### Means for Solving the Problem

The present invention is a vehicle conductor being used with an electric automobile, and includes a protection pipe to be mounted in the electric automobile, at least one wire inserted in the protection pipe and thereby constituting a power line of the electric automobile, and a cooling pipe inserted along the wire in the protection pipe so that a liquid coolant flows through the cooling pipe.

With this, heat generated in the wire is transferred in the protection pipe to cooling water flowing through the cooling pipe, and then dissipated outside the protection pipe.

Aspects of the present invention are preferably as follows:

(1) The protection pipe may be made of metal and have an electromagnetically shielding function.
(2) The wire may be wrapped around an outer periphery of the cooling pipe. With this, the wire does not depart far from the outer periphery of the cooling pipe, and therefore, heat dissipation performance from the wire to the cooling pipe is stabilized.
(3) A holder for accommodating the wire may be integrally formed on the outer side of the cooling pipe. With this, the wire does not depart far from the outer periphery of the cooling pipe, and therefore, heat dissipation performance from the wire to the cooling pipe is stabilized.
(4) By filling a heat transfer layer made of synthetic resin in a gap between the cooling pipe and the wire, the heat dissipation performance from the wire to the cooling pipe is stabilized.
(5) Three wires may be inserted in the protection pipe so that three-phase electric power be transmitted therethrough.
(6) A conductive portion of the wire may be a flat conductive portion. With this, one of the plane surfaces of the wire is disposed along the outer periphery of the cooling pipe. Therefore, a wider area for transferring the heat from the wire to the outer periphery of the cooling pipe is ensured, and superior heat dissipation efficiency is obtained.
(7) The cooling pipe may be made of metal and an insulating coat may be provided on the outer surface of the cooling pipe. Furthermore, in this case, a coating layer for collectively covering the wires in a state where the three wire are wrapped around an outer periphery of the insulating coat may be provided.

### EFFECTS OF THE INVENTION

The heat generated in the wire is forced to be carried away by the cooling water, and therefore it is superior in heat dissipation efficiency in comparison with the case of dissipating heat from the outer periphery of the protection pipe to the atmosphere.

### BRIEF DESCRIPTION OF THE INVENTION

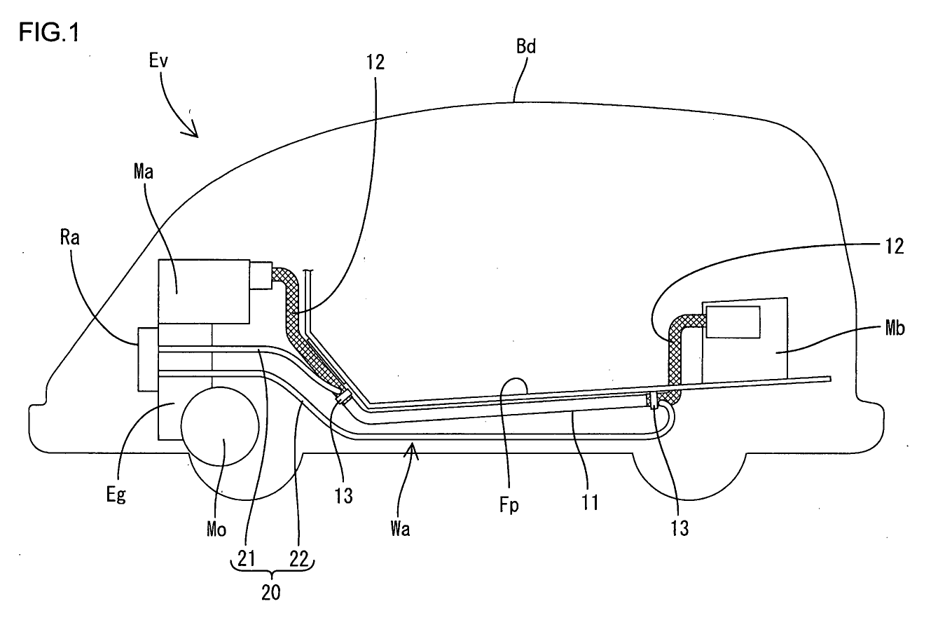

FIG. 1 is a schematic view of a first embodiment;

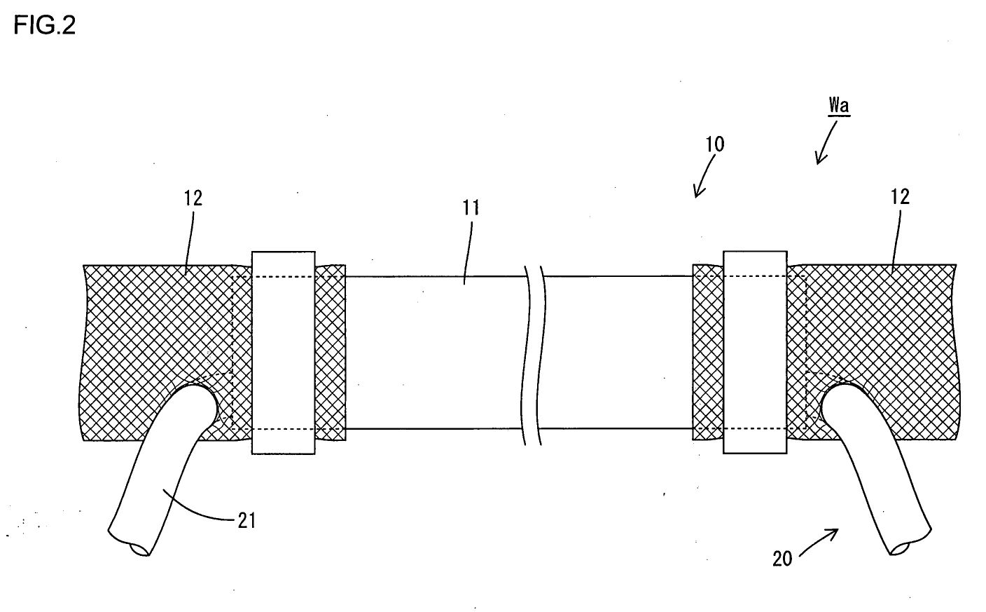

FIG. 2 is an enlarged partial side view;

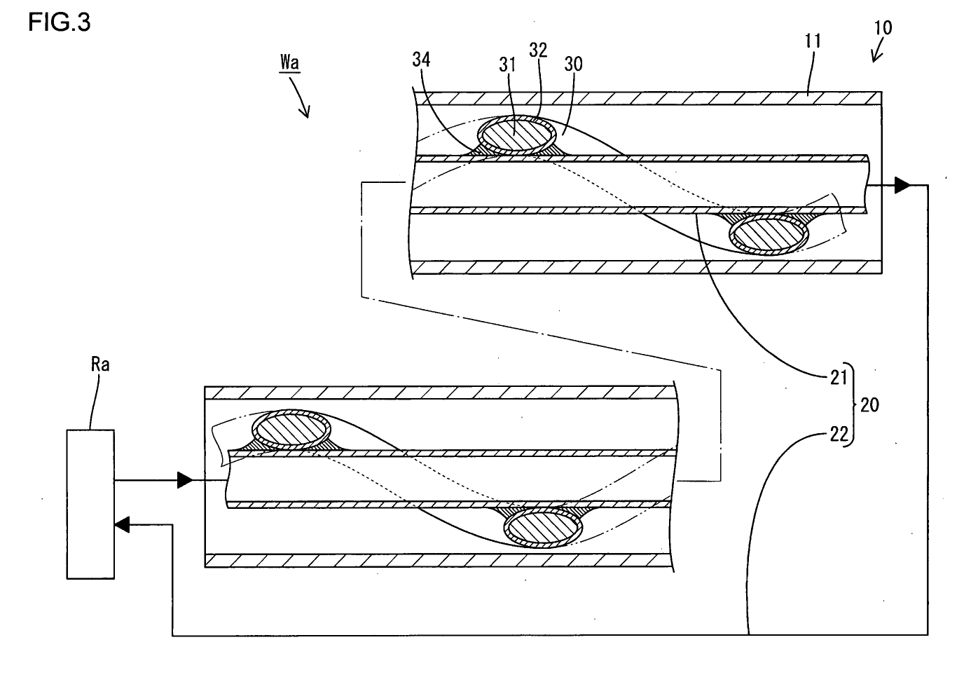

FIG. 3 is an enlarged partial longitudinal cross-sectional view;

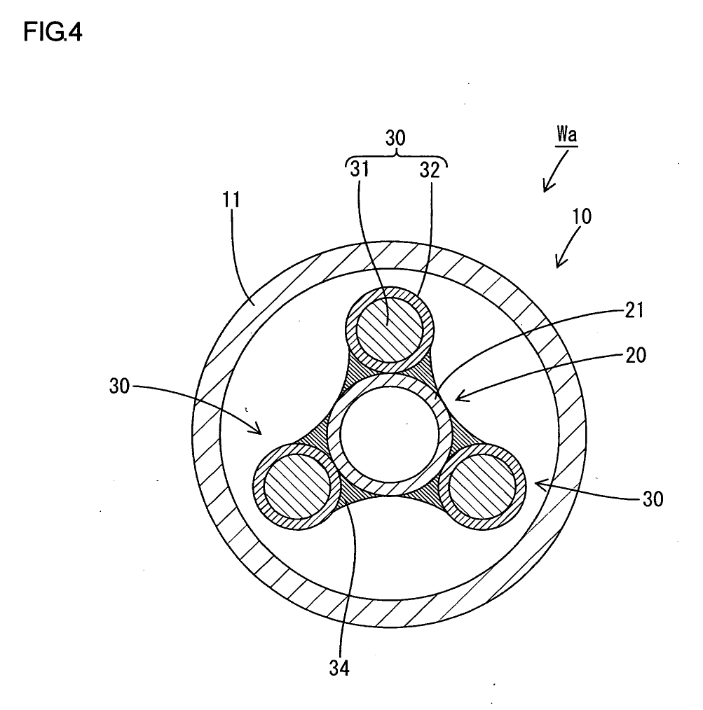

FIG. 4 is an enlarged partial transverse cross-sectional view;

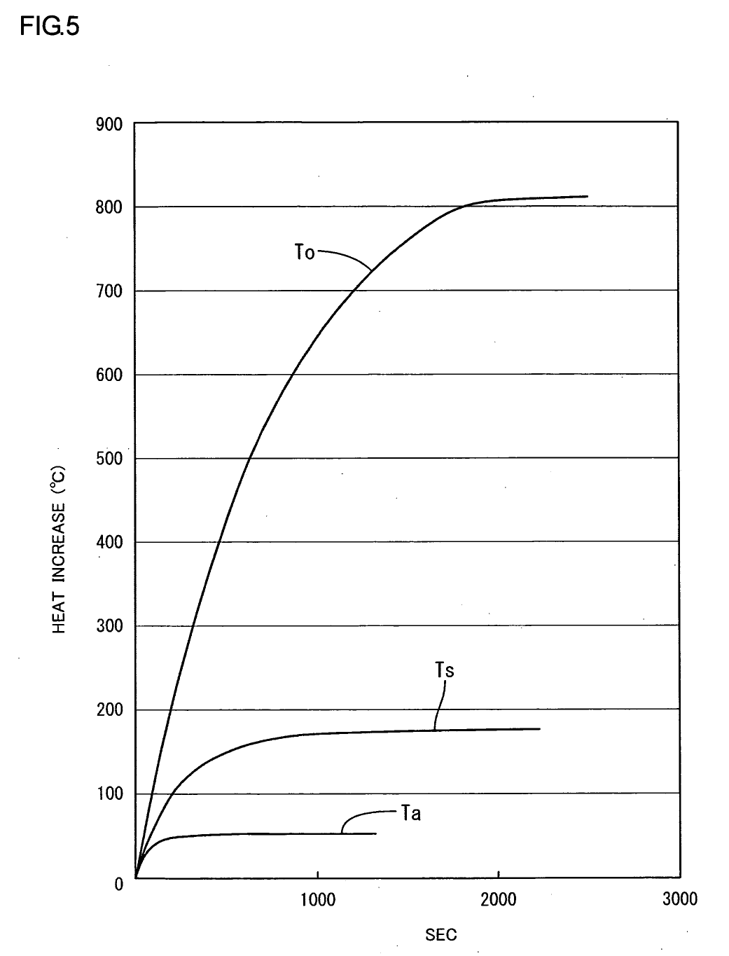

FIG. 5 is a graph showing results of temperature increase experiments;

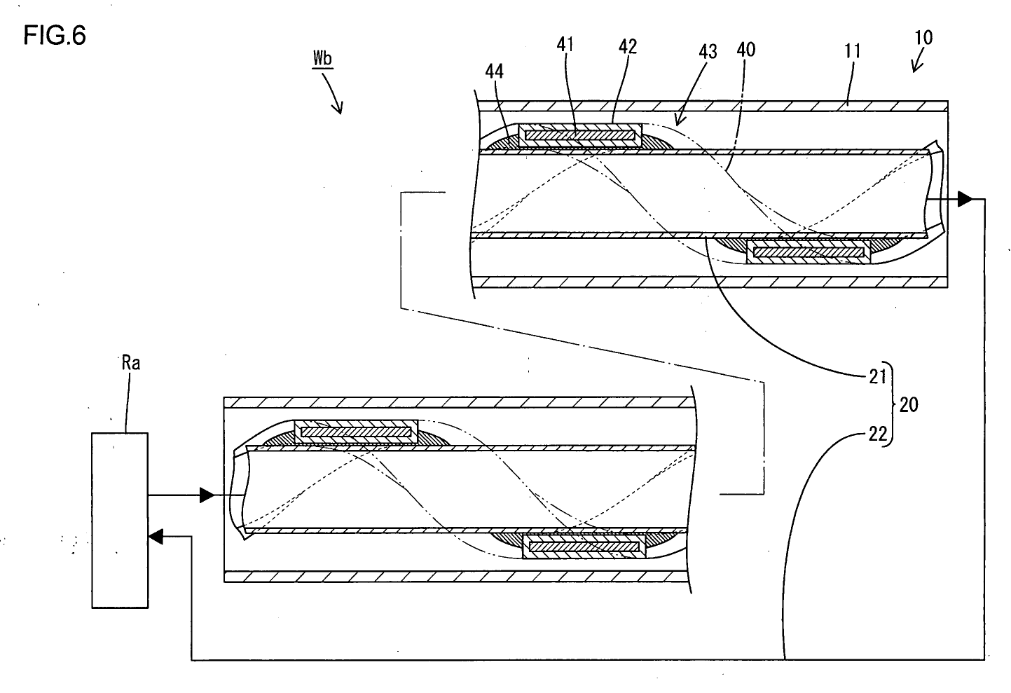

FIG. 6 is an enlarged partial longitudinal cross-sectional view of a second embodiment;

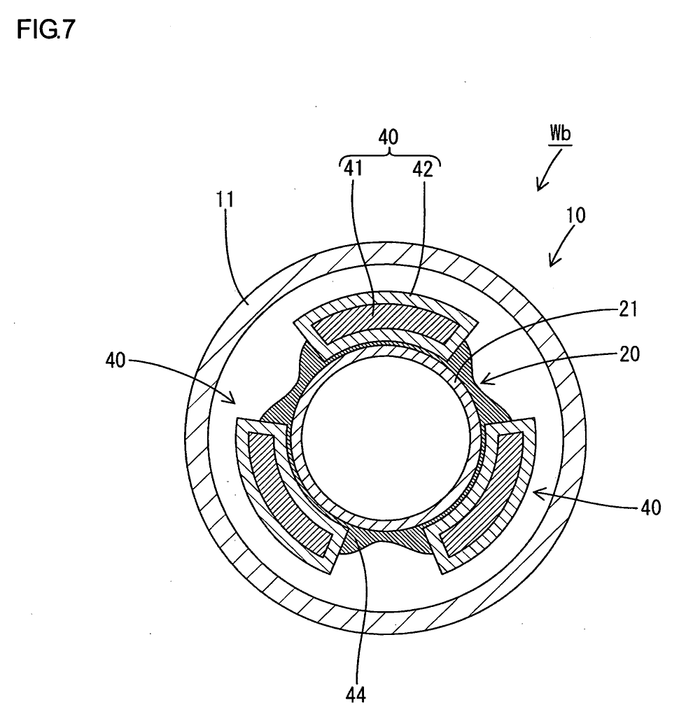

FIG. 7 is an enlarged partial transverse cross-sectional view;

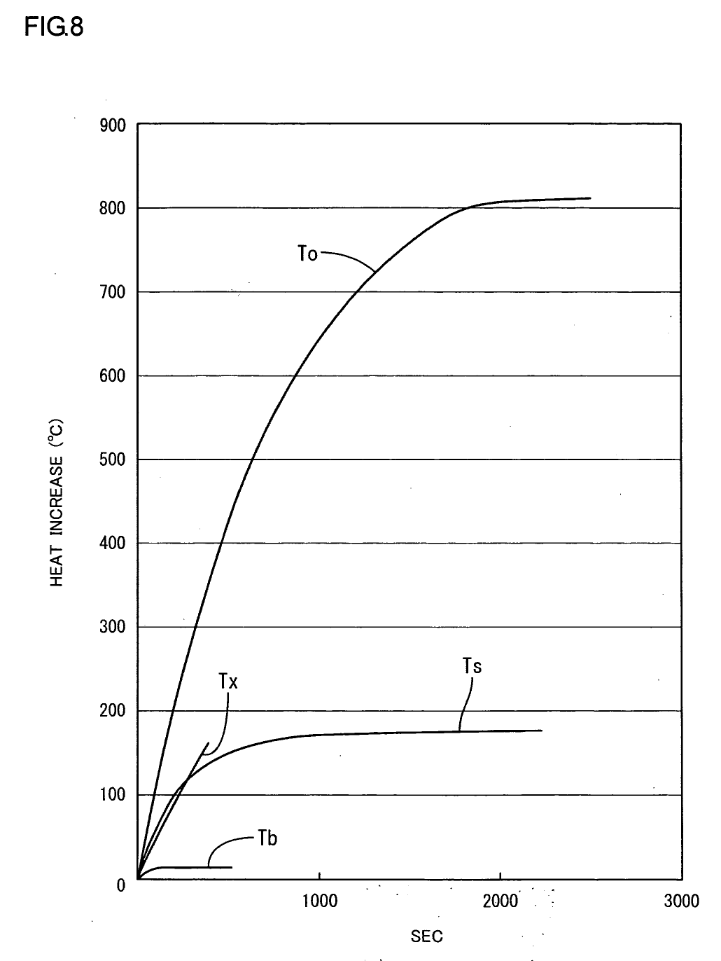

FIG. 8 is a graph showing results of temperature increase experiments;

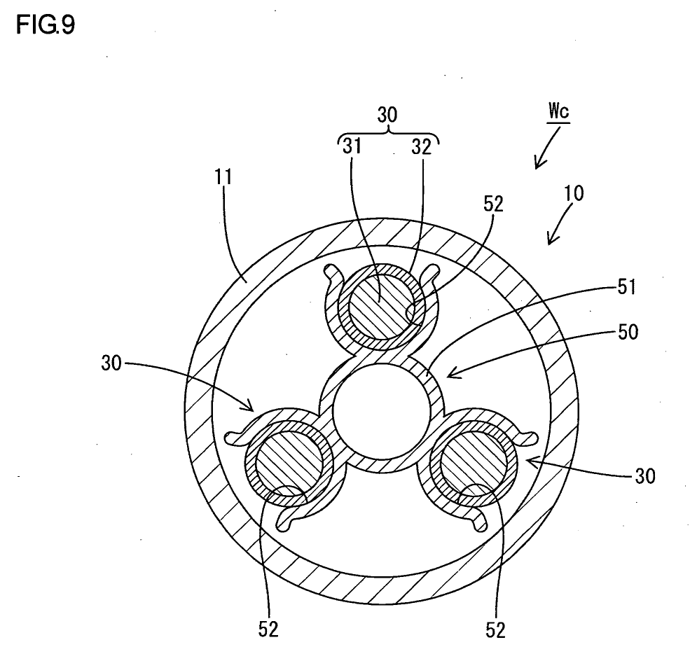

FIG. 9 is an transverse cross-sectional view of a third embodiment;

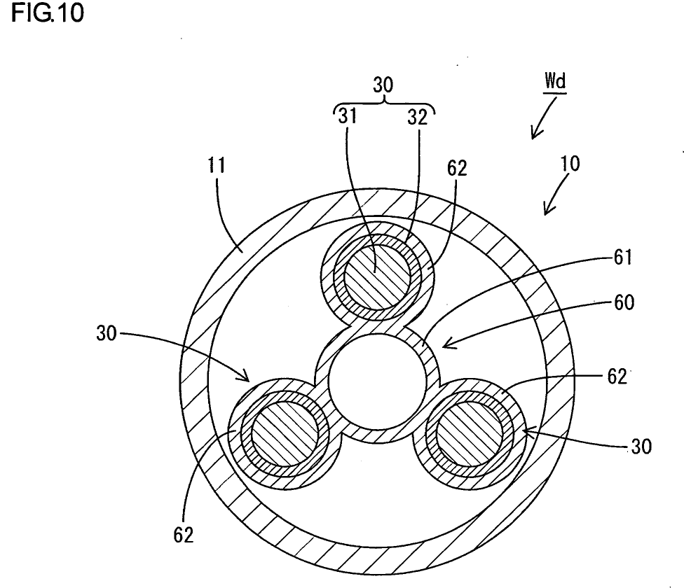

FIG. 10 is an transverse cross-sectional view of a fourth embodiment;

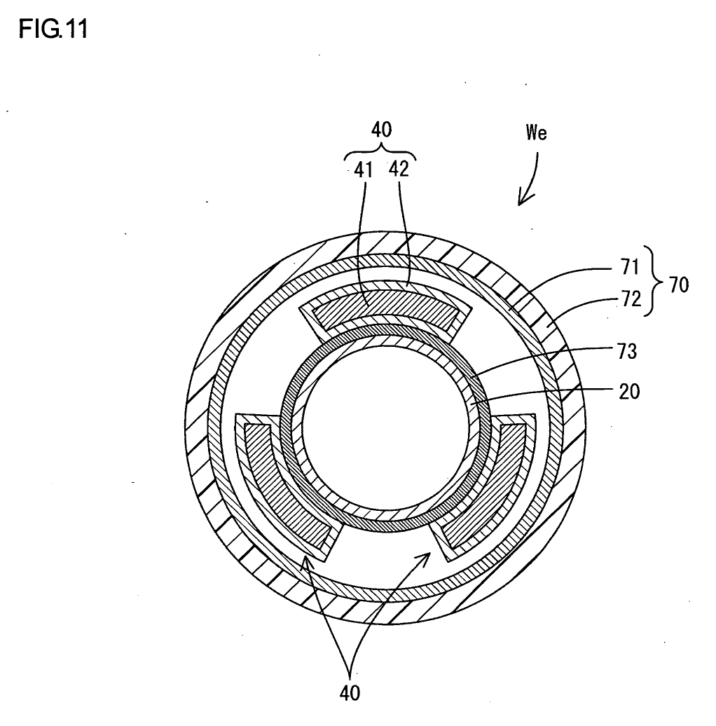

FIG. 11 is an transverse enlarged partial cross-sectional view of a fifth embodiment;

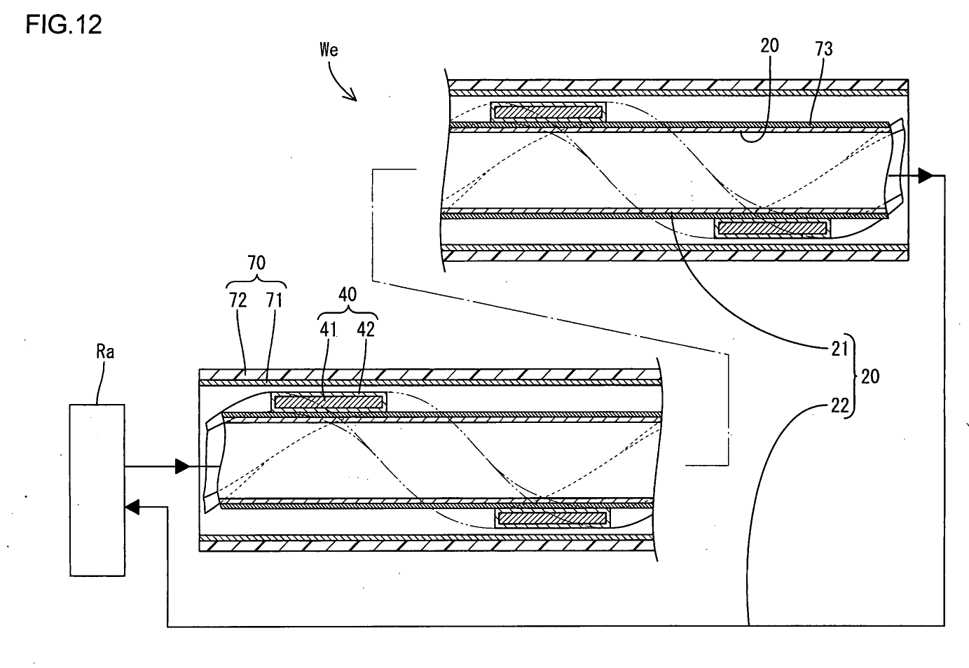

FIG. 12 is an enlarged partial longitudinal cross-sectional view of a fifth embodiment;

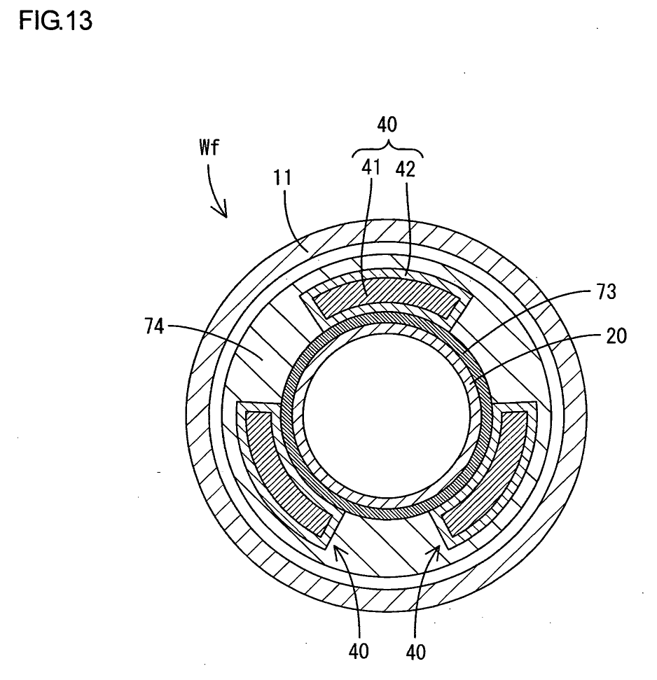

FIG. 13 is an enlarged partial transverse cross-sectional view of a sixth embodiment; and

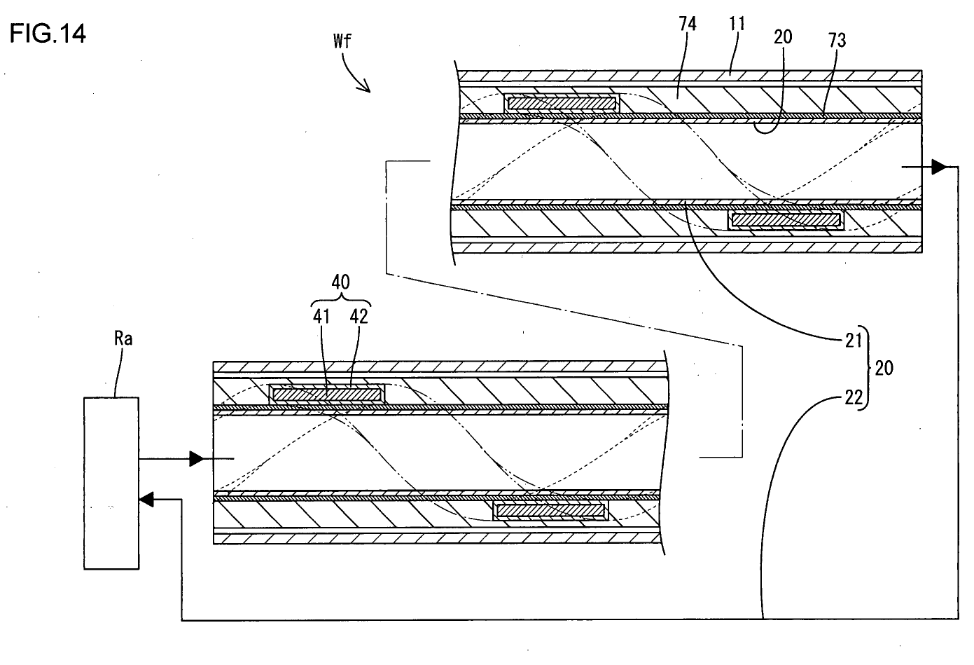

FIG. 14 is an enlarged partial longitudinal cross-sectional view of a sixth embodiment.

### EXPLANATION OF SYMBOLS

Wa . . . a vehicle conductor
11 . . . A protection pipe
20 . . . a cooling pipe
30 . . . a wire
34 . . . a heat transfer layer
Wb, Wc, Wd, We, Wf . . . a vehicle conductor
40 . . . a wire
41 . . . a conductive portion
44 . . . a heat transfer layer
50, 60 . . . a cooling pipe
52 . . . a grooved holder (a holder)
62 . . . a tubular holder (a holder)
70 . . . a protection pipe
73 . . . an insulating coat
74 . . . a coating layer

### BEST MODE FOR CARRYING OUT THE INVENTION

### First Embodiment

A first embodiment in accordance with the present invention will be hereinafter explained with reference to FIGS. 1 through 5. An electric vehicle EV includes a body Bd and an engine room provided in front of the body Bd. An equipment Ma (e.g. an inverter) and a gasoline engine Eg are accommodated in the engine room. The equipment Ma constitutes a driving circuit for driving a motor Mo. An equipment Mb (e.g. a battery) that constitutes another driving circuit is mounted in the rear (e.g. a trunk) of the body Bd. A vehicle conductor Wa for a vehicle runs between the equipment Ma and the equipment Mb.

The vehicle conductor Wa includes a cylindrical electromagnetically shielding member 10 having a collectively electromagnetically shielding function, a cooling pipe 20 having a heat dissipating function, and three wires 30 inserted in the shielding member 10.

The shielding member 10 includes a protection pipe 11 and flexible tubes 12. The protection pipe 11 is made of metal (e.g. aluminium alloy, stainless steel, copper, copper alloy, or the like), and has a protecting function as well as a collectively shielding function for the wires 30. Each of the flexible tubes 12 is formed of braided wires made by braiding thin metal wires into a mesh. The flexible tubes 12 are continuously fixed to front and rear ends of the protection pipe 11. The protection pipe 11 is circular in transverse cross section and runs along a lower surface of the floor (under a floor plate Fp) of the body Bd in a substantially horizontal posture. The front and rear ends of the protection pipe 11 is fixed in a suspended manner to the body Bd with brackets 13. One of the flexible tubes 12 which is connected to the front end of the protection pipe 11 runs through the engine room in a flexed shape and is connected to a shield case (not illustrated) of the equipment Ma. Another one of the flexible tubes 12 which is connected to the rear end of the protection pipe 11 penetrates the floor plate Fp, runs through the interior of the vehicle, and is connected to a shield case (not illustrated) of the equipment Mb.

The cooling pipe 20 is made of metal (e.g. aluminium alloy, stainless steel, copper, copper alloy, or the like), and is circular in transverse cross section. The cooling pipe 20 is constituted by a supply section 21 and a return section 22. The supply section 21 extends backward from a radiator Ra for cooling the engine Eg, through the engine room, and along a lower surface of the floor plate Fp. The return section 22 extends frontward from the rear end of the supply section 21, along the lower surface of the floor panel Fp, through the engine room, and returns to the radiator Ra. Cooling water (coolant) is circulated with a pump (not illustrated) through the radiator Ra, the inside of the supply section 21, and the inside of the return section 22, in that order.

In the supply section 21 of the cooling pipe 20, an area which extends backward along the lower surface of the floor panel Fp is inserted (accommodated) in the protection pipe 11. In the protection pipe 11, the cooling pipe 20 is substantially disposed in the axis of the protection pipe 11. In the supply section 21 of the cooling pipe 20, the other area which protrudes frontward from the protection pipe 11 is conducted to the outside of the flexible tube 12 through one of the pores defined by the wires of the braided wires at the vicinity of the front end of the protection pipe 11 (at a rear end of the front flexible tube 12). In the supply section 21 of the cooling pipe 20, a rear end portion that protrudes backward from the protection pipe 11 is conducted to the outside of the flexible tube 12 through one of the pores defined by the wires of the braided wires at the vicinity of the rear end of the protection pipe 11 (at a front end of the rear flexible tube 12). The return section 22 of the cooling pipe 20 runs outside the protection pipe 11 and the flexible tubes 12.

The wires 30 constitute a power line of the electric vehicle EV, and are configured such that three-phase electric power is transmitted therethrough. Each of the wires 30 is constituted by a non-shielded wire and is circular in transverse cross section. The non-shielded wire includes a flexible core 31 and an insulating resin sheath 32 enclosing the periphery of the core 31. The three wires 30 are collectively inserted in (enclosed with) the front flexible tube 12, the protection pipe 11, and the rear flexible tube 12. In the protection pipe, the three wires 30 run so as to be helically wrapped around the outer periphery of the cooling pipe 20, with being spaced at equal angles from each other in the circumferential direction and at equal pitches to each other. The outer periphery of the resin sheath 32 of each of the wires 30 and the outer periphery of the cooling pipe 20 are in line contact with each other along the helically running route of the wire 30.

Furthermore, the gap on the both sides of the line-contacting area between the outer periphery of the cooling pipe 20 and the periphery of the each wire 30 is filled with a heat transfer layer 34 that is constituted by a resin base composed of adhesive. The heat transfer layer 34 holds the each wire 30 such that the wire 30 is in line contact with the outer periphery of the cooling pipe 20. The heat transfer layer 34, as well as the helically wrapped shape of the wires 30, performs as a holding means for holding the each wire 30 in a state contacted with, or proximate to, the outer periphery of the cooling pipe 20. Note that FIG. 3 shows only a single one of the three wires 30 wrapped around the cooling pipe 20 so that the helically wrapped manner be easy to be comprehended. In addition, the three wires 30 run through the flexible tubes 12 with being collected in such a manner that lines connecting the centers (the centers of axes) of the wires 30 make an equilateral-triangular shape. The ends of each of the wires 30 are connected to the equipment Ma and the equipment Mb.

Next, functions of the present embodiment will be explained.

The heat generated in the cores 31 of each of the wires 30 when current flows therethrough is transferred from the core 31 to the resin sheath 32 and, inside the protection pipe 11, through (1) a route from the outer periphery of the resin sheath 32 directly to the outer periphery of the cooling pipe 20 or (2) from the outer periphery of the resin sheath 32 to the heat transfer layer 34 and from the heat transfer layer 34 to the outer periphery of the cooling pipe 20, to the cooling water flowing through the supply section 21 of the cooling pipe 20. The heat transferred to the cooling water is carried through the return section 22 of the cooling pipe 20, which runs outside the protection pipe 11, to the radiator Ra, and is dissipated from the outer surface of the radiator Ra to the atmosphere. In addition, a part of the heat is dissipated from the outer periphery of the cooling pipe 20 to the atmosphere by an air-cooling effect that is exerted by the wind passing over the return section 22 of the cooling pipe 20 when the vehicle is running.

In the present embodiment, the heat generated in the wires 30 is forced to be carried away by the cooling water. Therefore, the heat dissipation efficiency is better than the case of dissipating the heat from the outer periphery of the protection pipe 11 to the atmosphere. Furthermore, as holding means for holding the wires 30 in the state contact with the outer periphery of the cooling pipe 20, the wires 30 are helically wrapped around the outer periphery of the cooling pipe 20, while the wires 30 are secured to the outer periphery of the cooling pipe 20 with the heat transfer layer 34. Therefore, the wires 30 does not depart from the outer periphery of the cooling pipe 20, and the heat transfer performance for transferring the heat from the wires 30 to the cooling pipe 20 is stabilized.

Experiments have confirmed that the vehicle conductor Wa in accordance with the present embodiment is superior in heat dissipation in comparison with a conventional one. As a conventional example, a vehicle conductor having the protection pipe identical with that of the present embodiment and three wires inserted therein, while having no cooling pipe in the protection pipe, was put to the experiments. The conductive portion in each of the wires was made of copper, and the transverse cross sectional area of each of the conductive portions was 5.31 sq. It was windless around the protection pipe. Under such conditions, the variation of temperature in the wires with time when current of 60 ampere was continuously supplied through the three wires was monitored in the experiments, and based on the monitored values, extrapolated values of variation of temperature with time when current of 100 ampere is continuously supplied through conductive portions each of which is 3.5 sq. transverse cross-sectional area were calculated. Note that the previous external temperature before current went through the wires was used as a reference value for the monitored values and the extrapolated values. The calculation results are indicted as To in a graph of FIG. 5. As indicated in the graph, the temperature increase value reached 650° C. at the point when 1000 sec. passed.

In addition, as a reference example, a vehicle conductor having the protection pipe identical with that of the present embodiment, the three wires inserted therein, and resin filled in the gap between the protection pipe and the wires, while having no cooling pipe in the protection pipe, was also put to the experiments. The conductive portion in each of the wires was made of copper, and the transverse cross sectional area of each of the conductive portions was 5.31 sq. Wind was blowing against the outer periphery of the protection pipe. Under such conditions, the variation of temperature in the wires with time when current of 60 ampere was continuously supplied through the three wires was monitored in the experiments, and based on the monitored values, extrapolated values of variation of temperature with time when current of 100 ampere is supplied through conductive portions each of which is 3.5 sq. transverse cross-sectional area were calculated. Note that the previous external temperature before current went through the wires was used as a reference value for the monitored values and the extrapolated values. The calculation results are indicted as Ts in the graph of FIG. 5. As indicated in the graph, the temperature increase value was 170° C. at the point when 1000 sec. passed, i.e. it was restrained to a lower temperature than the counterpart of the conventional example.

On the other hand, the vehicle conductor according to the present embodiment had the wires 30 and the conductive portions 31 in the wires 30 made of copper. The transverse cross sectional area of each of the conductive portions 31 was 5.3 sq. The flow rate of the cooling water flowing through the cooling pipe 20 was 300 cc/13 sec. Wind was blowing against the outer periphery of the protection pipe 11. Under such conditions, the variation of temperature in the wires 30 with time when current of 100 ampere was continuously supplied through the three wires 30 was monitored in the experiments, and based on the monitored values, extrapolated values of variation of temperature in the wires 30 with time when current of 100 ampere is continuously supplied through conductive portions 31 each of which is 3.5 sq. transverse cross-sectional area is were calculated. Note that the previous temperature of the cooling water flowing through the cooling pipe 20 before current went through the wires was used as a reference value for the monitored values and the extrapolated values. The calculation results are indicted as Ta in the graph of FIG. 5. As indicated in the graph, the temperature increase value was restrained to approximately 50° C., i.e. to a lower temperature, at the point when 1000 sec. passed. Specifically, after 200 sec. passed, the temperature increase value was kept at approximately 50° C., i.e. in a substantially constant temperature state. From these results of the experiments, it was proved that the vehicle conductor Wa in accordance with the present embodiment is superior in the heat dissipation in comparison with the conventional and the reference examples.

### Second Embodiment

Next, a second embodiment in accordance with the present invention will be explained with reference to FIGS. 6 and 8. A vehicle conductor Wb includes wires 40 having different configurations from those of the first embodiment. Other configurations are similar to the first embodiment, and therefore are designated by the same numerals, while explanations on the constructions, the functions, and the effects are omitted.

Each of the wires 40 is rectangular in transverse cross section as a whole. Specifically, the cross section of the each wire 40 is substantially I-shaped with the long sides being extremely longer than the short sides. The each wire 40 has a long and thin plate shape (a band plate shape or a plane plate shape) as a whole. A conductive portion 41 included in the each wire 40 is a rectangular conductive portion having a rectangular transverse cross-sectional shape. The insulating resin sheath 42 that encloses each of the conductive portions 41 has a rectangular frame cross-sectional shape. The wires 40 are helically wrapped around the outer periphery of the cooling pipe 20, with one of the plane surfaces of the width side being in parallel with, and proximate to, the outer periphery of the cooling pipe 20. By the helically wrapped shape, the wires 40 are held in a state proximate to the outer periphery of the cooling pipe 20. Furthermore, the gap between the surface of the each wire 40 and the outer periphery of the cooling pipe 20, that are proximately opposing each other, is filled with a heat transfer layer 44 composed of adhesive. By the heat transfer layer 44 the wires 40 are held in the state proximate to the outer periphery of the cooling pipe 20. The heat transfer layer 44 constitutes a holding means for holding the wires 40 in the state proximate to the outer periphery of the cooling pipe 20. Note that the heat transfer layer 44 is applied also to the area extending from the surfaces of the thickness side of the each wire 40 to the outer periphery of the cooling pipe 20, thereby enhancing the adhesive strength.

In the present embodiment, the conductive portion 41 of the each wire 40 is a flat conductive portion having a long and thin plate shape, and the each wire 40 is provided on the cooling pipe 20 with one of the surfaces of the conductive portion 41 being disposed along the outer periphery of the cooling pipe 20. A wider area for transferring the heat from the wire 40 to the outer periphery of the cooling pipe 20 is thus ensured. Therefore, it is superior in the heat transfer performance in comparison with the one in accordance with the first embodiment, where each of the wires 30 having a circular cross-sectional shape is in line contact with the cooling pipe 20.

Experiments have clearly confirmed that the vehicle conductor Wb in accordance with the present embodiment is superior in heat dissipation in comparison with a conventional one. As a conventional example, a vehicle conductor having the protection pipe identical with that of the present embodiment and three wires inserted therein, while having no cooling pipe in the protection pipe, was put to the experiments. The conductive portion in each of the wires was made of copper, and the transverse cross sectional area of each of the conductive portions was 5.31 sq. It was windless around the protection pipe. Under such conditions, the variation of temperature in the wires with time when current of 60 ampere was continuously supplied through the three wires was monitored in the experiments, and based on the monitored values, extrapolated values of variation of temperature with time when current of 100 ampere is continuously supplied through conductive portions each of which is 3.5 sq. transverse cross-sectional area were calculated. Note that the previous external temperature before current went through the wires was used as a reference value for the monitored values and the extrapolated values. The calculation results are indicted as To in a graph of FIG. 8. As indicated in the graph, the temperature increase value reached 650° C. at the point when 1000 sec. passed.

In addition, as a reference example, a vehicle conductor having the protection pipe identical with that of the present embodiment, the three wires inserted therein, and resin filled in the gap between the protection pipe and the wires, while having no cooling pipe in the protection pipe, was also put to the experiments. The conductive portion of each of the wires was made of copper, and the transverse cross sectional area of each of the conductive portions was 5.31 sq. Wind was blowing against the outer periphery of the protection pipe. Under such conditions, the variation of temperature in the wires with time when current of 60 ampere was continuously supplied through the three wires was monitored in the experiments, and based on the monitored values, extrapolated values of variation of temperature with time when current of 100 ampere is supplied through conductive portions each of which transverse cross-sectional area is 3.5 sq. were calculated. Note that the previous external temperature before current went through the wires was used as a reference value for the monitored values and the extrapolated values. The calculation results are indicted as Ts in the graph of FIG. 8. As indicated in the graph, the temperature increase value was 170° C. at the point when 1000 sec. passed, i.e. was restrained to a lower temperature than the counterpart of the conventional example.

On the other hand, the vehicle conductor according to the present embodiment had the wires 40 and the conductive portions 41 in the wires 40 made of copper. The transverse cross-sectional area of each of the conductive portions 41 was 3.5 sq (4.5 mm width and 0.8 mm thick). Wind was blowing against the outer periphery of the protection pipe 11. The variation of temperature in the wires 40 with time when current of 100 ampere was continuously supplied through the three wires 30, while the flow rate of the cooling water flowing through the cooling pipe 20 was 300 cc/13 sec., was monitored by the experiments. The previous temperature of the cooling water flowing through the cooling pipe 20 before current went through the wires was used as a reference value for the monitored values. The calculation results are indicted as Tb in the graph of FIG. 8. As indicated in the graph, the temperature increase value was restrained to approximately 13° C., i.e. to a lower temperature, at the point when 500 sec. passed. Specifically, after 100 sec. passed, the temperature increase value was kept at approximately 13° C., i.e. in a substantially constant temperature state. From these results of the experiments, it was proved that the vehicle conductor Wb in accordance with the present embodiment is superior in the heat dissipation efficiency in comparison with the conventional and the reference examples.

In addition, the variation of temperature in the vehicle conductor Wb was monitored also under the conditions identical with the above ones excepting that the cooling water was not supplied through the cooling pipe 20. The monitoring results are indicated as Tx in the graph of FIG. 8. In this case, immediately after current started flowing through the wires, the temperature was rapidly increased with the gradient similar to the gradient of the reference example. The results of the experiments clearly confirmed that the cooling function by the cooling pipe 20 is significantly effective.

### Third Embodiment

Next, a third embodiment in accordance with the present invention will be explained with reference to FIG. 9. A vehicle conductor Wc in accordance with the present embodiment includes the holding means for holding the wires 30 in the state being in contact with, or proximate to, the outer periphery of a cooling pipe 50. The form of the holding means is different from the counterpart in accordance with the first embodiment. Other configurations are similar to the first embodiment, and therefore are designated by the same numerals, while explanations on the constructions, the functions, and the effects are omitted.

The cooling pipe 50 in accordance with the present embodiment includes a pipe body 51 and three grooved holders 52 (the holder that is one of the elements of the present invention). The pipe body 51 is circular in cross section and passes the cooling water therethrough. The grooved holders 52 are formed on the outer periphery of the pipe body 51 with being spaced at equal angles from each other in the circumferential direction of the outer periphery of the pipe body 51. The grooved holders 52 may extend either in parallel with the axis of the pipe body 51 or helically with being inclined with respect to the axis of the pipe body 51. In each of the grooved holders 52, a wire 30 is fitted.

Note that groove of the each grooved holder 52 opens in the direction opposite from the pipe body 51. Accordingly, in order to prevent the wires 30 from coming off the grooves, a tape (not illustrated) may be wrapped all over the cooling pipe 50 so as to enclose it. The tape then covers the opening of the grooves of the grooved holders 52, thereby preventing the wires 30 from coming off the grooved holders 52.

Note that, in the present embodiment, a single wire 30 is fitted in each of the grooved holders 52. However, a plurality of wires may be fitted in a single grooved holder.

### Fourth Embodiment

Next, a fourth embodiment in accordance with the present invention will be explained with reference to FIG. 10. A vehicle conductor Wd in accordance with the present embodiment includes the holding means for holding the wires 30 in the state in contact with, or proximate to, the outer periphery of a cooling pipe 60. The form of the holding means is different from the counterpart in accordance with the first embodiment. Other configurations are similar to the first embodiment, and therefore are designated by the same numerals, while explanations on the constructions, the functions, and the effects are omitted.

The cooling pipe 60 in accordance with the present embodiment includes a pipe body 61 and three tubular holders 62 (the holder that is one of the elements of the present invention). The pipe body 61 is circular in cross sectional and passes the cooling water therethrough. The tubular holders 62 are formed on the outer periphery of the pipe body 61 with being spaced at equal angles from each other in the circumferential direction of the outer periphery of the pipe body 61. The tubular holders 62 may extend either in parallel with the axis of the pipe body 61 or helically with being inclined with respect to the axis of the pipe body 61. In each of the grooved holders 62, a wire 30 is inserted.

Note that, in the present embodiment, a single wire 30 is inserted in each of the tubular holders 62. However, a plurality of wires may be inserted in a single tubular holder.

### Fifth Embodiment

Next, a fifth embodiment in accordance with the present invention will be explained with reference to FIGS. 11 and 12. A vehicle conductor We in accordance with the present embodiment includes a two-layered protection pipe 70 constituted by an inner pipe 71 and an outer pipe 72. The combination of the inner pipe 71 and the outer pipe 72 may be either the inner pipe 71 and the outer pipe both made of resin, the inner pipe 71 made of resin and the outer pipe 72 made of metal, or the inner pipe 71 made of metal and the outer pipe 72 made of resin.

An insulating coat 73 is formed continuously and with even thickness all over the length and the circumference of the outer periphery of the metal cooling pipe 20. The insulating coat 73 is constituted by a resin base composed of adhesive. The three wires 40 are wrapped around the outer periphery of the insulating coat 73 and secured thereto by the adhesive force of the insulating coat 73. Each of the wires 40, similarly to the one in accordance with the second embodiment, includes the flat conductive portion 41 and the insulating resin sheath 42 enclosing the conductive portion 41.

In the present embodiment, the insulating coat 73 intervenes in the gap between the wires 40 and the outer periphery of the cooling pipe 20. Therefore, the resin sheaths 42 of the wires 40 can be thinner.

Other configurations are similar to the second embodiment, and therefore are designated by the same numerals, while explanations on the constructions, the functions, and the effects are omitted.

### Sixth Embodiment

Next, a sixth embodiment in accordance with the present invention will be explained with reference to FIGS. 13 and 14. A vehicle conductor Wf in accordance with the present embodiment, similarly to the one in accordance with the fifth embodiment, includes an insulating coat 73 having even thickness continuously over the entire length and the entire circumference of the outer periphery of the metal cooling pipe 20. The insulating coat 73 is constituted by a resin base composed of adhesive. The three wires 40 are helically wrapped around the outer periphery of the insulating coat 73 and secured thereto by the adhering force of the insulating coat 73. Each of the wires 40, similarly to the one in accordance with the second and fifth embodiment, includes the flat conductive portion 41 and the insulating resin sheath 442 enclosing the conductive portion 41.

The vehicle conductor Wf in accordance with the present embodiment, furthermore, includes a resin coating layer 74 enclosing the entire length and the entire circumference of the insulating layer 73. The coating layer 74 collectively encloses the three wires 40. That is, the three wires 40 are embedded in the coating layer 74.

Note that the protection pipe 11 is similar to the one in accordance with the first embodiment. Other configurations are similar to the second embodiment, and therefore the same configurations are designated by the same numerals, while explanations on the constructions, the functions, and the effects are omitted.

### Other Embodiments

The present invention is not limited to the embodiments explained by the foregoing description with reference to the drawings. For example, the following embodiments are also included within the scope of the present invention.

(1) In accordance with the first through sixth embodiments, the protection pipe is circular in transverse cross section. However, in accordance with the present invention, it may be noncircular (e.g. elliptical, oval, generally square, generally polygonal, or generally trapezoidal) in transverse cross section.

(2) In accordance with the first through sixth embodiments, three wires are inserted in the single protection pipe. However, in accordance with the present invention, the number of wires inserted in the single protection pipe may be a single, two, four or more.

(3) In the first through sixth embodiments, non-shielded wires are used as the wires. However, in accordance with the present invention, heat pipes having a heat dissipating function may be used as the conductive wires.

(4) In the first through sixth embodiments, a single cooling pipe is inserted in the single protection pipe. However, in accordance with the present invention, a plurality of cooling pipes may be inserted in the single protection pipe.

(5) In the first through sixth embodiments, the cooling water of the radiator for the engine (another equipment) is passed through the cooling pipe. However, in accordance with the present invention, instead of the cooling water of a cooler for another equipment (the engine, the inverter, or the like), cooling water dedicated for cooling the wires may be used.

(6) In the first through sixth embodiments, the cooling pipe is made of metal. However, in accordance with the present invention, the cooling pipe may be made of synthetic resin.

(7) In the first, second, fifth, and sixth embodiments, the cooling pipe is circular in transverse cross section, while, in the third and fourth embodiments, the pipe body is circular in transverse cross section. However, in accordance with the present invention, the cooling pipe or the pipe body may be noncircular (e.g. elliptical, oval, generally square, generally polygonal, or generally trapezoidal) in transverse cross section.

(8) In the first through sixth embodiments, three wires are disposed along the single cooling pipe. However, in accordance with the present invention, the number of wires disposed along the single pipe may be a single, two, four, or more.

(9) In the first, second, fifth, and sixth embodiments, the wires are helically wrapped around the outer periphery of the cooling pipe. However, in accordance with the present invention, the wires may run substantially in parallel with the axis of the cooling pipe.

(10) In the first, second, fifth, and sixth embodiments, the wires and the cooling pipe are fixed to each other with the heat transfer layer (a resin base) composed of adhesive. In accordance with the present invention, however, the first, second, fifth, or sixth embodiment may be configured without fixing the wires and the cooling pipes to each other with the adhesive.

(11) In the first through sixth embodiments, as a means for holding the wires in the state being in contact with, or proximate to, the outer periphery of the cooling pipe, the wires are helically wrapped around the outer periphery of the cooling pipe and adhered thereto, fitted in the grooved holders, or inserted in the tubular holders. However, in accordance with the present invention, means other than the wires are fixed to the outer periphery of the cooling pipe with a band or a tape may be also adopted.

(12) In the first, second, fifth, and sixth embodiments, as a means for holding the wires in the state being in contact with, or proximate to, the outer periphery of the cooling pipe, the wires are helically wrapped around the outer periphery of the cooling pipe and, furthermore, adhered thereto. However, in accordance with the present invention, only either one of the means for the wires are helically wrapped around the outer periphery of the cooling pipe and the means for the wires adhered to the outer periphery of the cooling pipe may be adopted as the holding means.

(13) In the first embodiment, the outer periphery of the insulating coat of each of the wires is in direct contact with the outer periphery of the cooling pipe. However, in accordance with the present invention, it may be configured such that the outer periphery of each of the wires is not in direct contact with the outer periphery of the cooling pipe.

(14) In the second, fifth, and sixth embodiments, the outer periphery of the insulating coat of each of the wires is not in direct contact with the outer periphery of the cooling pipe. However, in accordance with the present invention, the outer periphery of each of the wires may be in direct contact with the outer periphery of the cooling pipe.

(15) In the first through sixth embodiments, the wires run along the cooling pipe only inside the protection pipe, while the wires are apart from the cooling pipe outside the protection pipe. However, in accordance with the present invention, the wires may run along the cooling pipe also outside of the protection pipe (inside any one of the flexible tubes).

(16) In the first through sixth embodiments, the supply section of the cooling pipe is inserted in the protection pipe, while the return section of the cooling pipe runs outside the protection pipe. However, in accordance with the present invention, it may be configured such that the supply section of the cooling pipe runs outside the protection pipe, while the return section of the cooling pipe is inserted in the protection pipe.

(17) In the first through fourth, and sixth embodiments, the protection pipe is made of metal. However, in accordance with the present invention, the protection pipe may be made of synthetic resin such as a corrugated tube.

(18) In the first through sixth embodiments, the inside of the cooling pipe is connected to the radiator so that cooling water be circulated. However, in accordance with the present invention, a heat pipe with containing coolant hermetically sealed therein may be used as the cooling pipe. In this case, when the heat pipe is positioned partially outside the protection pipe and is functioned as a heat dissipating section, higher heat dissipation performance can be obtained.

(19) The construction in the sixth embodiment that three wires are collectively covered with the coating layer can be applied to any one of the first through fifth embodiments.

1-9. (canceled)

10. A vehicle conductor for use with an electric automobile, comprising:
a protection pipe, including at least one wire in the protection pipe capable of supplying power, and a cooling pipe positioned proximate the at least one wire in the protection pipe.

11. The vehicle conductor according to claim 10, wherein the protection pipe is made of metal and is capable of electromagnetic shielding.

12. The vehicle conductor according to claim 11, wherein the wire is wrapped around an outer periphery of the cooling pipe.

13. The vehicle conductor according to claim 12, further comprising a holder for accommodating the wire, the holder being integrally positioned on the outer periphery of the cooling pipe.

14. The vehicle conductor according to claim 13, further comprising a heat transfer layer made of synthetic resin, the heat transfer layer positioned in a gap between the cooling pipe and the wire.

15. The vehicle conductor according to claim 14, wherein the at least one wire comprises three wire members, the three wire members positioned in the protection pipe capable of transmitting three-phase electric power.

16. The vehicle conductor according to claim 15, wherein a conductive portion of the wire is flat.

17. The vehicle conductor according to claim 16, wherein the cooling pipe is made of metal, and the outer surface of the cooling pipe includes an insulating coat.
